(19) United States
(12) Patent Application Publication
(10) Pub. No.: US 2026/0326874 A1
(43) Pub. Date: Oct. 22, 2026

(54) A MARINE DRIVE UNIT WITH AN EFFICIENT INTEGRATED COOLING CIRCUIT

(71) Applicant: VOLVO PENTA CORPORATION, Göteborg (SE)

(72) Inventors: Stig JOHANSSON, Torslanda (SE); Lars-Gunnar CARLSSON, Torslanda (SE); Anders RYDSTRÖM, Göteborg (SE)

(73) Assignee: VOLVO PENTA CORPORATION, Göteborg (SE)

(21) Appl. No.: 19/105,528

(22) PCT Filed: Aug. 22, 2023
(86) PCT No.: PCT/EP2023/072963

§ 371 Date: Feb. 21, 2025

(30) Foreign Application Priority Data
Sep. 6, 2022 (SE) 2251032-5

(51) Int. Cl. B63H 20/28

(52) U.S. Cl. CPC B63H 20/28

(57) ABSTRACT

A drive unit for a marine vessel has a drive unit body with a first part and a second part. The first part of the drive unit body is arranged elongated along a center plane of the drive unit and supports a propeller shaft on a lower end, where the center plane is vertical and extends in a longitudinal direction of the marine vessel in use. The second part of the drive unit body is attached to the first part at an upper end of the first part and extends along a hull plane perpendicular to the center plane and extending in a lateral direction of the marine vessel in use. The drive unit body has a closed cooling compartment fluidly connected to a closed cooling circuit configurable to cool one or more electric components of the marine vessel. The closed cooling compartment has an extension parallel to the hull plane in the second part which exceeds the extension parallel to the hull plane in the first part.

### TECHNICAL FIELD

The present disclosure relates to marine drive units suitable for use with electric machines to provide propulsion in marine vessels such as leisure craft and sail boats. The drive units comprise closed cooling circuits which have been designed to provide high efficiency in the heat transfer between coolant and surrounding seawater through the body of the drive unit.

### BACKGROUND

Electrically powered marine vessels are becoming more and more common. With the change from combustion engines to electric machines as primary power source for propulsion, new challenges and opportunities have arisen in the design of the surrounding components of the drive system, such as the drive unit which supports the propeller arrangement in the water along with the arrangement for transferring torque between power source and propeller shaft.

For instance, modifications and improvements in the cooling system that cools the electric machine and surrounding components such as the electrical energy storage and power electronics are possible. Combustion engines on boats are normally cooled by seawater that is run either directly through the motor or through a heat exchanger. Outboard engines can be directly cooled by seawater with a water intake and a water outlet at the lower part of the engine, close to the propeller. Inboard engines provided, e.g., with a sterndrive normally has a water inlet and a water outlet in the sterndrive or arranged through the vessel hull.

These cooling arrangements function well, but there are some maintenance problems associated with using seawater as coolant, especially salt seawater, running through the cooling system.

Drive units comprise rotating parts in need of lubrication. It is desired to provide a lubrication system which is efficient and at the same time cost effective. Since spatially efficient drive units are desired, compact lubrication systems are preferred. At the same time, marine propulsion systems should be both mechanically robust and easy to maintain.

Space is often limited on a marine vessel; hence compact drive units are highly desired. This desire for compact design is often in conflict with, e.g., cooling requirements of the drive unit components.

### SUMMARY

It is an objective of the present disclosure to provide more efficient marine drive units. This objective is at least in part obtained by a drive unit for a marine vessel. The drive unit comprises a drive unit body with a first part and a second part. The first part of the drive unit body is arranged elongated along a center plane of the drive unit and supports a propeller shaft on a lower end. The center plane being vertical and extending in a longitudinal direction of the marine vessel in use. The second part of the drive unit body is attached to the first part at an upper end of the first part and arranged extending along a hull plane perpendicular to the center plane and extending in a lateral direction of the marine vessel in use. The drive unit body comprises a closed cooling compartment arranged to be fluidly connected to a closed cooling circuit configurable to cool one or more electric components of the marine vessel, where the closed cooling compartment has an extension parallel to the hull plane in the second part which exceeds the extension parallel to the hull plane in the first part. This means that the closed cooling compartment extends to follow the contour of the hull of the vessel at the interface between hull and drive unit. This extension increases the contact area of the closed cooling compartment against the surrounding seawater and therefore increases the cooling efficiency of the system, which is an advantage.

According to some aspects, a plurality of ribs is formed in the first part of the drive unit body arranged to protrude into the closed cooling compartment. The ribs extend in a direction parallel to the center plane and transversal to a coolant flow in the closed cooling compartment. The ribs disturb the laminar flow of the coolant, and therefore increase the heat transfer between coolant and the surrounding seawater. The closed cooling compartment can optionally be separated into two parts by an inner wall aligned with the center plane, where additional ribs are arranged protruding out from the inner wall and into the closed cooling compartment. The ribs provide increased cooling capacity, and also increase the stiffness and mechanical strength of the drive unit, in particular its ability to resist bending.

The ribs arranged protruding out from the inner wall can be offset with respect to ribs protruding into the closed cooling compartment from an outer wall of the drive unit body to further promote heat transfer between coolant and surrounding seawater.

According to some aspects, external fins are configured to extend out from the second part parallel to the center plane. These fins do not hamper drag performance significantly but increase the effective contact surface with the surrounding seawater, through which heat may propagate from the coolant to the surrounding seawater. The drive unit body can also be at least partly formed in a Manganese bronze alloy or in Nibral, which are materials well suited for transferring heat from the coolant to the surrounding seawater in an efficient manner.

The closed cooling compartment is preferably arranged in a forward part of the drive unit and facing in a travelling direction of the marine vessel in use. This location allows for a relatively large contact area with the surrounding seawater, with maintained hydrodynamic performance compared to if the closed cooling compartment would have been located in the rear of the drive unit.

Marine vessels are also disclosed herein which are associated with the above discussed advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

With reference to the appended drawings, below follows a more detailed description of embodiments of the invention cited as examples. In the drawings:

FIG. 1 schematically illustrates a marine vessel comprising an example drive unit;

FIG. 2 shows a front view of an example marine vessel drive unit;

FIG. 3 illustrates a cutout side view of an example drive unit;

FIG. 4A illustrates another cutout side view of an example drive unit;

FIG. 4B is a cross section top view of an example drive unit;

FIGS. 5-6 show cross section top views of example drive units;

FIGS. 7A-D show cross section longitudinal views of an example drive unit;

FIG. 8 schematically illustrates a drive unit with an integrated coolant pump;

FIG. 9 illustrates a drive unit geometry with conduits for coolant and lubricant;

FIG. 10 shows details of an oil channel arrangement in a drive unit;

FIG. 11 illustrates details of a closed cooling compartment in a drive unit; and

FIGS. 12-13 show details of a planetary gear arrangement.

### DETAILED DESCRIPTION OF EXAMPLE EMBODIMENTS OF THE INVENTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

In the example drawings and accompanying description, a number of drive unit features are described in a context where the features are integrated into a compact example design. It is, however, appreciated that the features can often be used separately and do not necessarily depend on each other. For instance, features related to the cooling system can often be separated from the lubrication system. Geometrical features of the drive unit are not inextricably linked to the features of the comprised components.

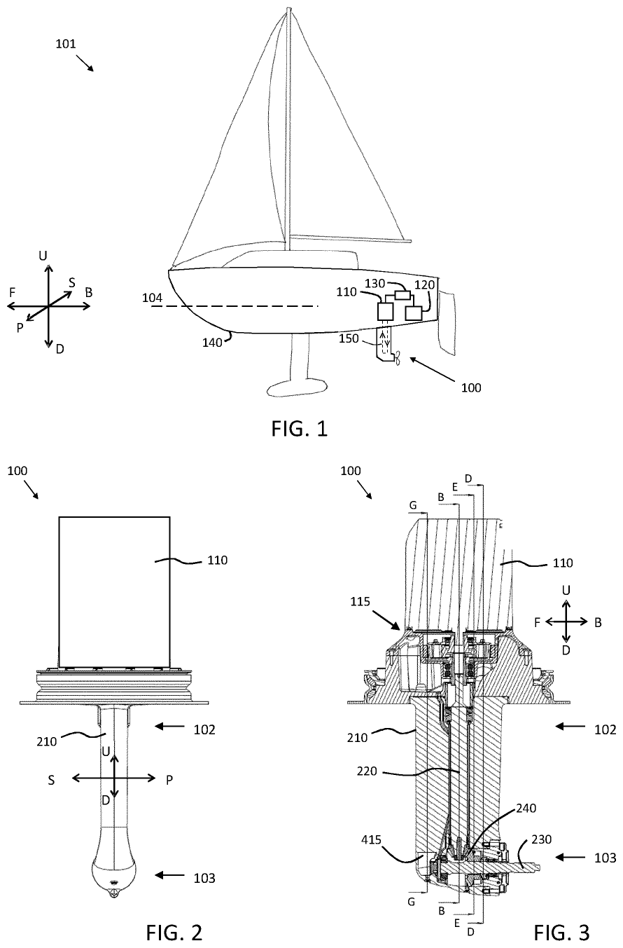

FIG. 1 schematically illustrates an example marine vessel 101, in this case a sailing boat, provided with a marine drive unit 100 for propelling and optionally also for steering the vessel. The propulsion system of the vessel 101 comprises an electric machine 110 connected to the drive unit 100, an electric energy storage system (ESS) 120 and an electronic control unit (ECU) 130 configured to control the rotational speed and the rotational direction of the electric motor. The ECU 130 is controlled by a boat control system. In the shown example, a sailboat comprising a single drive unit is shown. The example drive units presented herein can, however, of course also be used in other types of boats, such as power boats and smaller commercial vessels, potentially also comprising a plurality of drive units arranged on various locations of the hull 140.

The ESS 120 may comprise, e.g., a battery, a super-capacitor, a fuel cell arrangement, or any other type of electrical energy storage system.

The drive unit 100 is mounted on the bottom of the vessel, i.e., below the hull 140. At least some of the drive units discussed herein comprise a closed cooling circuit 150 which extends down into the drive unit where heat in the coolant is transferred to the surrounding seawater. The closed cooling compartment is closed in the sense that there is no connection to the surrounding seawater, i.e., it is sealed from the ambient seawater. This closed cooling circuit 150 will be discussed in more detail below. More than one electric machine can be used to drive one or more propellers and/or thrusters on the vessel 101. A marine vessel may also comprise two or more drive units arranged at different parts on the vessel, such as a stern drive combined with a bow thruster or the like.

A number of reference directions are defined in FIG. 1, which will be used throughout the present disclosure. The directions relate to the drive unit and marine vessel in use. A vertical direction extends upwards U and downwards D with respect to the vessel and drive unit in use, as illustrated in FIG. 1. The vertical direction is normal to a calm sea surface 104 when the marine vessel is in use. A longitudinal direction extends forwards F and backwards B. The longitudinal direction may also be referred to as a travel direction of the marine vessel 101. A lateral direction extends perpendicular to the longitudinal direction, from a port side P to a starboard side S of the vessel 101. The longitudinal and lateral directions extend in a horizontal plane, to which the vertical direction is normal. The drive unit 100 has a forward part and a back part, as well as an upper part and a lower part. The forward part of the drive unit faces in the forward travel direction of the vessel in use, while the back part faces in the opposite direction, i.e., towards the stern when the vessel is in use.

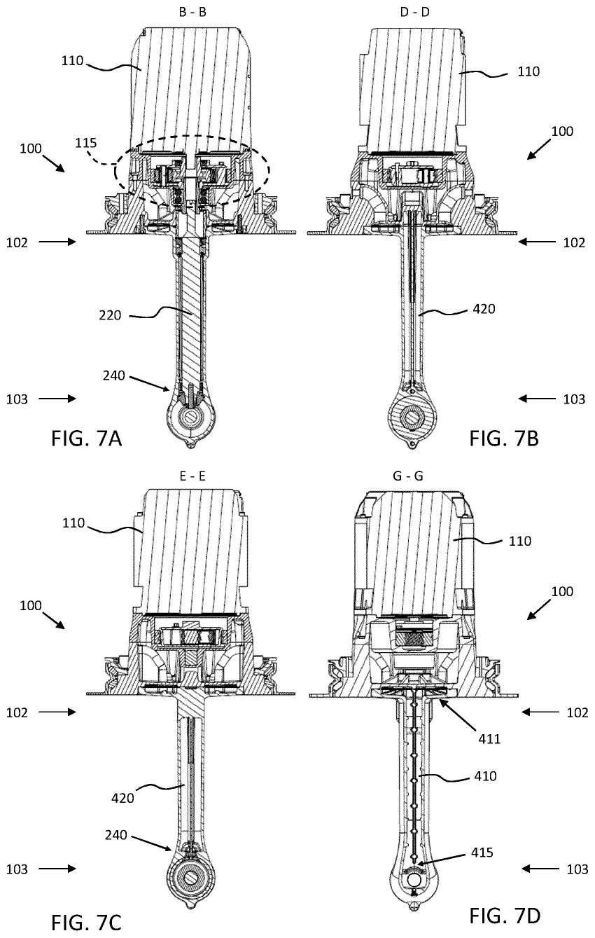

FIG. 2 shows a front view of an example drive unit 100 and FIG. 3 illustrates a section side view of the drive unit seen from its port side. The drive unit 100 comprises a drive unit body 210 which supports a drive shaft 220 that extends from an upper end 102 to a lower end 103 of the drive unit. A propeller shaft 230 is connected to the drive shaft 220 via a bevel gear transmission arrangement 240. The drive unit 100 also comprises a motor interface 115 arranged to support an electric machine 110 and to transfer torque from the electric machine 110 to the drive shaft 220. It is appreciated that the electric machine may be integrally formed with the drive unit, or separate from the drive unit, i.e., manufactured and sold separately from the drive unit. FIG. 3 also defines the locations of cross sectional views B-B, D-D, E-E and G-G which will be discussed in more detail below in connection to FIGS. 7A-D.

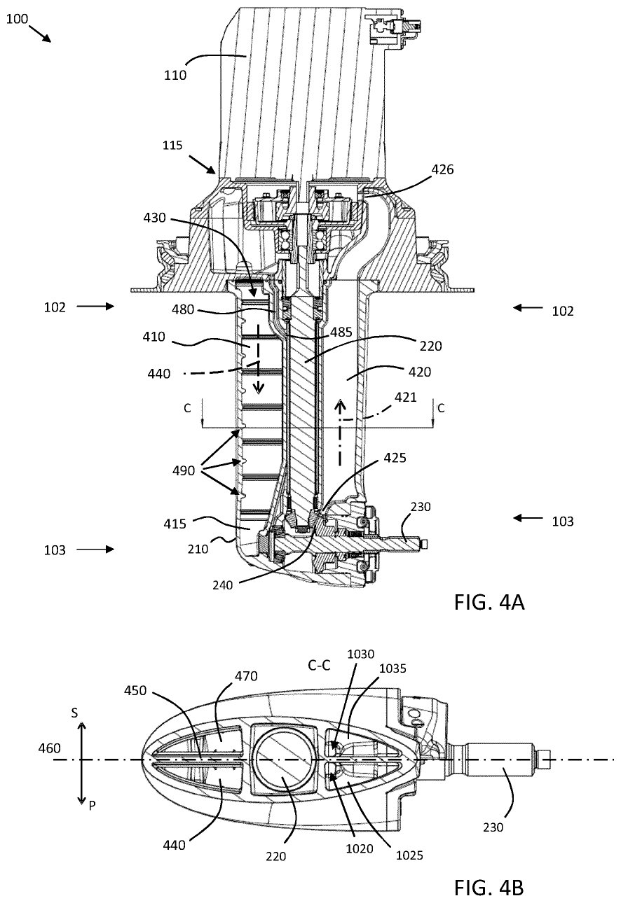

FIGS. 4A-B show cutout section views of an example drive unit 100. This example drive unit 100 comprises a closed cooling compartment 410 arranged in the forward part of the body 210 of the drive unit, i.e., the part of the drive unit 100 that in use is directed in the forward travelling direction F of the vessel 101. The closed cooling compartment 410 suitably forms part of the closed cooling circuit 150 of the vessel schematically illustrated in FIG. 1. The cooling circuit 150 extends between one or more of the propulsion components 110, 120, 130 and the cooling compartment 410. The cooling circuit 150 may also comprise an expansion reservoir provided with a controllable valve, adapted to regulate the flow through the cooling circuit.

The cooling compartment 410 illustrated in FIGS. 4A and 4B comprises an inlet opening 430 arranged at the upper end 102 of the drive unit 100 which provides access to an inlet channel 440 that extends down into the drive unit towards its lower end 103. The inlet channel 440 connects via an aperture 415 (seen more clearly in FIG. 7D) to an outlet channel 470 at the lower end 103 (indicated in FIG. 4B), which then extends up through the drive unit 100 to an outlet opening (not shown in FIG. 4A). Thus, both the inlet opening and the outlet opening of the cooling compartment 410 are arranged at the upper end 102 of the body 210, in connection to the plane or surface where the drive unit 100 is attached to the hull 140. This means that the cooling compartment can be accessed from inside the hull, where it may interface with one or more cooling systems of the marine vessel 101.

The inlet opening 430 and the outlet opening may, e.g., be formed as circular sleeves extending from the body 210 to which a tubing or the like can be attached. The sleeve may be straight or may be angled. The inlet opening 430 receives cooling fluid from a cooling system of the vessel through some form of conduit, such as a tubular conduit, and the outlet opening then forwards the cooled down cooling fluid back to the cooling system through another tubing. The inlet channel 430 forms part of a first flow path for the cooling fluid from the inlet opening 430 at the upper end 102 to the lower end 103 of the cooling compartment 410. The outlet channel forms part of a second flow path for the cooling fluid from the lower end 103 of the cooling compartment 410 to the outlet opening arranged at the upper end 102 of the body 210.

The cooling fluid of the closed cooling circuit 150 in the example of FIGS. 4A-B flows through the first flow path down into the drive unit and up through the second flow path where it will dissipate heat through the outer wall of the drive unit 100 to the surrounding seawater. One advantage of the example drive unit 100 is that when the boat travels faster and more power is used, more water will flow through the drive unit, which will increase the cooling capacity of the system.

The inlet channel 440 is in one example formed by a separate tube or conduit extending from the inlet opening 430 to the lower end 103 of the closed cooling compartment 410, arranged to feed a cooling liquid to the lower end of the cooling compartment. From the lower end 103, the cooling liquid will flow upwards through the outlet channel of the closed cooling compartment 410 to the outlet opening.

The inlet channel and the outlet channel may also be formed by an inner wall 450 as illustrated in FIG. 4B. In this example, the inlet channel is formed between the inner wall and part of the inner side of the body on a port side P of the drive unit 100, and the outlet channel is formed between the inner wall and part of the inner side of the body on a starboard side S of the drive unit 100. The inner wall 450 extends to the lower end 103 of the closed cooling compartment 440 where an aperture 415 in the inner wall 450 connects the inlet channel to the outlet channel. This aperture 415 can be seen more clearly in FIG. 3 and also in FIG. 7D. The coolant flow through the closed cooling compartment can of course also be in the opposite direction, e.g., such that the inlet channel is formed on the port side and the outlet channel is formed on the starboard side of the inner wall 450.

The example inner wall 450 illustrated in FIG. 4B is central in the closed cooling compartment 410 and is parallel with a center plane 460 of the drive unit 100. The center plane 460 is aligned with the forward direction F of the vessel. The center plane 460 is normally vertical when the drive unit is in use. The cross section area of the inlet channel and the outlet channel may be the same or they may be different from each other. In one example, the cross section of the inlet channel is smaller than the outlet channel. It is also possible to position the inner wall 450 in a direction transversal or even perpendicular to the center plane 460. In this case, the flow paths will not be arranged side by side, but one flow path will be arranged in front of the other.

It is appreciated that more than one side wall can be arranged in the drive unit to define more than two flow paths for the cooling liquid. For instance, the cooling compartment 410 may be provided with a second inner wall, such that the cooling compartment comprises four flow paths. In this example, the cooling fluid can be arranged to flow down to the lower end 103 of the cooling compartment 410 through the first flow path. At the lower end of the cooling compartment, the first flow path is connected to the second flow path by an aperture in the first inner wall such that the cooling fluid can flow upwards in the drive unit to the upper end 102 of the cooling compartment 410. At the upper end, the second flow path is connected to the third flow path, through which the cooling fluid will flow downwards again to the lower end 103 of the cooling compartment 410. At the lower end of the cooling compartment, the third flow path is connected to the fourth flow path such that the cooling fluid flows upwards towards the upper end of the cooling compartment and to the outlet opening and further onwards through the cooling system of the vessel 101. In this way, a continuous flow path for the cooling fluid is created from the inlet opening to the outlet opening.

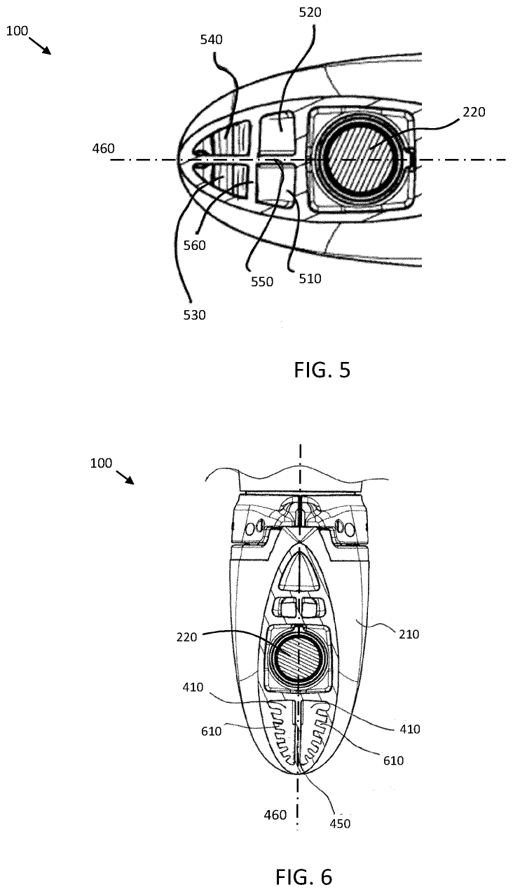

FIG. 5 shows an example drive unit 100 which comprises four flow paths 510, 520, 530, 540 separated from each other by a first inner wall 550 and by a second inner wall 560. The coolant in the closed cooling system here flows first through a first flow path 510 down into the drive unit, then up through a second flow path 520, before it again flows down into the drive unit in a third flow path 530 and once more up through the drive unit in a fourth flow path 540. The flow paths are connected in series by apertures formed in the two inner walls 550, 560.

A technical effect of using more than one inner wall to generate more than two flow paths in the drive unit is that the total path length through the closed cooling compartment becomes longer, which allows the coolant more time to transfer heat to the surrounding seawater, given a flow rate through the cooling compartment.

FIG. 6 shows another example of a closed cooling compartment 410 where the inner side of the drive unit body 210 is provided with protruding elements 610 that extend into the flow path of the inlet and/or outlet channel. The protruding elements are in the shown example longitudinal fins or ribs arranged along the flow direction of the cooling fluid. The fins will enlarge the cooling surface of the flow paths and therefore improve the heat transfer between the coolant and the surrounding seawater. When the inner wall 450 divides the cooling compartment in a longitudinal direction along the center plane 460, fins may be provided in both the inlet channel and the outlet channel. When the inner wall 450 divides the cooling compartment in a cross direction transversal to the forward direction, fins may be provided only in the forward channel having a larger contact surface to the surrounding water. The protruding elements may also be elements arranged to disturb the laminar flow of the cooling fluid, e.g., protruding buttons or a chevron pattern, such that the heat exchange through the outer wall is increased.

FIGS. 7A-D show cross section longitudinal views of an example drive unit, seen from the forward part of the drive unit. The different cross section views are defined in FIG. 4A.

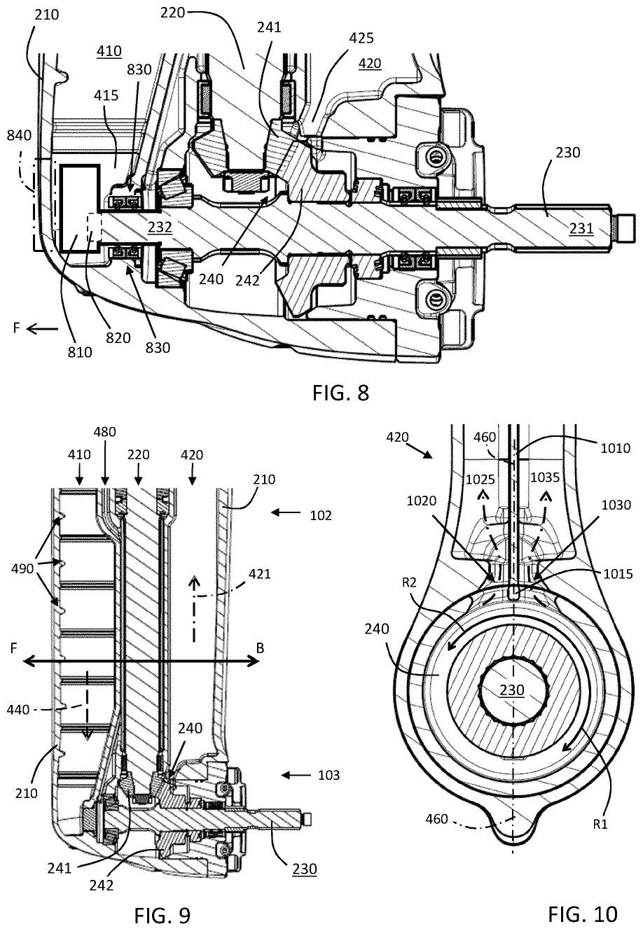

FIG. 8 illustrates an example drive unit 100 which comprises a closed cooling compartment 410 arranged in an elongated drive unit body 210. The closed cooling compartment 410 is arranged to be fluidly connected to the closed cooling circuit 150 of a marine vessel such as the sailing boat discussed above. The drive unit 100 comprises a propeller shaft 230 arranged at a lower end 103 of the drive unit 100. The propeller shaft 230 extends in a center plane 460 of the drive unit 100 (indicated, e.g., in FIG. 4B) from a propeller end 231 to a forward end 232 of the propeller shaft 230. In this example, a coolant pump 810 is connected 820 to the forward end 232 of the propeller shaft 230 and arranged to pump coolant through the closed cooling compartment 410. Thus, advantageously, this drive unit comprises an integrated coolant pump powered by the propeller shaft 230. An interesting feature of this set-up is that the coolant pump will pump more coolant when the propeller shaft rotates at high speed, and less coolant when the propeller shaft rotates at low speed. Thus, the cooling capacity of the system will automatically be adjusted to the cooling requirements of the propulsion system of the vessel 101. The coolant pump 810 is preferably bidirectional, such that it will pump coolant through the closed cooling compartment 410 in one direction when the propeller rotates in one direction, and pump coolant in the opposite direction through the closed cooling compartment 410 when the propeller is rotated in reverse direction. This provides efficient cooling when driving in a forward direction as well as when reversing.

According to an example, a drive shaft 220 extends from an electric motor interface 115 at an upper end 102 of the drive unit 100 to the lower end 103, where the drive shaft 220 is connected to the propeller shaft 230 via a bevel gear arrangement 240 arranged in-between the propeller end 231 and the forward end 232 of the propeller shaft 230, as illustrated in FIG. 8. This way power to the propeller and to the coolant pump is transferred using the same drive shaft, which is spatially efficient. The coolant pump 810 and the bevel gear 242 of the propeller shaft are preferably arranged on opposite sides of the drive shaft 220 to provide a compact design. As shown in FIG. 8, the closed cooling compartment 410 and the coolant pump 810 can be arranged in the front part of the drive unit, i.e., facing in the forward direction F of the drive unit 100.

Many different types of coolant pumps can be envisioned, but a centrifugal pump arranged to be driven by rotation of the propeller shaft 230 is preferred due to simplicity. A centrifugal pump can be designed to require a small amount of maintenance, which is an advantage. According to some aspects, an inspection and service hatch 840 can be arranged in the forward part of the drive unit body 210, through which the coolant pump 810 can be accessed and inspected, as well as serviced if need be.

Having a coolant pump 810 in the lower end of the drive unit arranged to be driven by the propeller shaft 230 may be particularly advantageous in a drive unit design where the electric machine is also integrated in the lower end of the drive unit. In this case a cooling circuit can be designed which is contained in the drive unit, which could be an advantage. An electric machine integrated into the lower end of the drive unit may be a stand-alone electric machine, in which case there is no need for the drive shaft 220. It can, however, also be comprised in a hybrid drivetrain, which comprises the drive shaft that extends up to a combustion engine arranged inside the hull 140 of the vessel 101.

The closed cooling compartment 410 can be arranged to hold an oil-based coolant or a water-based coolant. An oil-based coolant has the associated advantage that the same oil can be used both for lubrication of the rotating parts in the drive unit and for cooling. However, the cooling capacity of oil-based coolants are often inferior to that of water-based coolants, such as water with anti-freeze additives. In case the closed cooling compartment 410 is arranged to hold a water-based coolant, then a watertight seal 830 is preferably arranged around the propeller shaft 230 in connection to the forward end 232 of the propeller shaft 230, as exemplified in FIG. 8. This seal 830 separates the water compartments of the drive unit from oil compartments 420 used for lubrication.

The coolant pump 810 may as noted above be directly connected to the propeller shaft 230, meaning that it will rotate at the same speed as the propeller. Some coolant pumps may not be able to support such high rotation speeds. In such cases, a geared transmission 820 of some kind can be arranged between the propeller shaft 230 and the coolant pump 810. This geared transmission can be configured to reduce the rotation speed of the pump relative to the propeller shaft to a suitable value at which the coolant pump can operate in an efficient manner without excessive wear. The geared transmission can advantageously be arranged on the bevel gear side of the propeller shaft relative to the watertight seal 830, and thus receive lubrication from the same oil channel as the bevel gear arrangement 240.

The drive unit 100 optionally comprises an inner wall 450, 550, 560, examples of which are illustrated in FIG. 4B and FIG. 5, configured to separate the closed cooling compartment 410 into an inlet channel 440 and an outlet channel 470. The inner wall 450, 550, 560 also comprises an aperture 415 arranged at the lower end 103 of the drive unit 100 which connects the inlet channel to the outlet channel. The coolant pump 810 is preferably arranged in connection to this aperture 415 formed in the inner wall 450, 550, 560.

FIG. 9 illustrates details of a drive unit 100 for a marine vessel 101 where a particularly advantageous geometry has been selected, i.e., a particularly advantageous relative ordering of the different components and conduits of the drive unit from front F to back B. The closed cooling compartment 410 is arranged in the front part of the drive unit, followed by the drive shaft 220 which is located in the center part of the drive unit, in turn followed by an oil channel 420 which is arranged in the back part B of the drive unit body 210 behind the drive shaft 220. It is advantageous to locate the closed cooling compartment at the front of the drive unit since this location provides the best possibility to dissipate thermal energy to the surrounding seawater through the material of the drive unit body. The rear part of the drive unit can then contain the oil channel for lubricating the bevel gear and the propeller shaft.

The drive shaft 220 preferably extends in the center plane 460 and terminates in a bevel gear arrangement 240 which rotatably connects the drive shaft 220 to the propeller shaft 230 in an efficient manner.

The drive unit 100 may also comprise an oil return channel 480 arranged between the closed cooling compartment 410 and the oil channel 420. This oil return channel 480 terminates in a port 485 arranged facing the drive shaft 220, and thus the return flow of oil lubricates the drive shaft on its way down to the bevel gear arrangement 425 and the propeller shaft 230, which is an advantage.

According to some aspects, the drive unit 100 comprises a plurality of ribs 490, 495 formed in the drive unit body 210 and arranged protruding out into the closed cooling compartment 410. These ribs are arranged to disturb the laminar flow of the coolant in the closed cooling compartment, which improves the heat transfer between the coolant and the surrounding seawater. The ribs also increase the rigidity of the drive unit 100 and increases its mechanical strength and ability to withstand impact, which is an advantage. As shown in FIG. 9, the ribs 490, 495 extend horizontally in use, which is transversal to the direction of the coolant flow 412, 413. The extension direction of the ribs increases the ability of the drive unit to resist bending forces generated by the propeller in use, which is an advantage. The ribs also provide an increased resistance to lateral bending of the drive unit in use.

FIG. 9 and FIG. 10 also illustrate some interesting details relating to the oil channel 420 which is arranged to provide lubrication for the different moving parts of the drive unit 100 by means of a flow of oil 421, 1025, 1035 which enters the drive unit 100 via the return channel 480 and is pushed up through the drive unit via the oil channel 420. FIG. 10 shows an example drive unit 100 comprising an elongated drive unit body 210 arranged to support a propeller shaft 230 at a lower end 103 and a motor interface 115 at an upper end 102 of the drive unit body 210 (not shown in FIG. 10). The propeller shaft 230 extends in a center plane 460 of the drive unit 100, as in the other examples discussed herein. A drive shaft 220 is arranged extending from the motor interface 115 through the drive unit body 210 to a bevel gear arrangement 240 arranged to rotatably connect the drive shaft 220 to the propeller shaft 230. The bevel gear arrangement 240 comprises a first bevel gear 241 arranged on the drive shaft 220 and a second bevel gear 242 arranged on the propeller shaft 231 to cooperate with the first bevel gear 241. This means that the first bevel gear 241 rotates in a horizontal plane (when in use) to drive a second bevel gear 242 which rotates in a vertical plane perpendicular to the center plane 460. It is appreciated that an angle between the drive shaft and the propeller shaft can also be realized using an angled bevel gear in a known manner.

The second bevel gear 242 brings the lubricant into rotation when the propeller shaft is rotated. With reference to FIG. 10, if the propeller shaft 230 is rotated in clockwise direction R1, then the lubricant will be forced upwards on the port side of the center plane 460 and downwards on the starboard side of the center plane. If the propeller shaft is instead rotated in counter-clockwise direction R2, then the lubricant will be forced upwards on the starboard side of the center plane 460 and downwards on the port side of the center plane 460.

It is desired to maintain an upwards flow of oil 421 in the oil channel 420, away from the propeller axle 230 through the drive unit body 210 in direction of the motor interface 115, regardless of rotation direction of the propeller shaft. To accomplish this, the oil channel 420 has an input aperture 425 arranged in connection to the second bevel gear 242 which comprises a first aperture part 1020 and a second aperture part 1030 arranged separated by the center plane 460 and facing the second bevel gear 242. This means that an upwards flow of oil 1025 is generated through the first aperture part 1020 if the propeller shaft 230 is rotated in the clockwise direction R1, and that an upwards flow of oil 1035 is generated through the second aperture part 1030 if the propeller shaft 230 is rotated in the counter-clockwise direction R2. Consequently, an upwards flow of oil is generated through the oil channel 420 regardless of rotation direction of the propeller shaft 230. This is an advantage since lubrication is maintained regardless of propeller drive direction, without complex oil pumping arrangements or the like. As for the coolant, the flow of oil increases with propeller speed, which is advantageous since most components require a higher amount of lubricant when operating at high speeds.

The example oil channel 420 is separated into first and second oil conduits 1025, 1035 by a separating wall 1010, where the first aperture part 1020 opens up into the first oil conduit 1025 and the second aperture part 1030 opens up into the second oil conduit 1035. However, tubular conduits of some form can of course also be used.

The separating wall 1010 can be aligned with the center plane 460, rendering the cross section areas of the first and second oil conduits 1025, 1035 the same size, although this is not necessary. For instance, a higher propeller shaft speed can in some cases be expected when the vessel is travelling in the forward direction compared to when it is reversing, and the pumping pressure generated by this oil pump arrangement may therefore differ depending on the rotation direction of the propeller shaft. To compensate for this difference in pumping pressure, the cross section areas of the oil channel conduits connected to the first aperture part 1020 and to the second aperture part 1030 may be configured differently. In particular, the oil conduit receiving oil during reversing may be formed with a smaller volume compared to the conduit receiving oil during forward drive, to compensate for the difference in generated pressure.

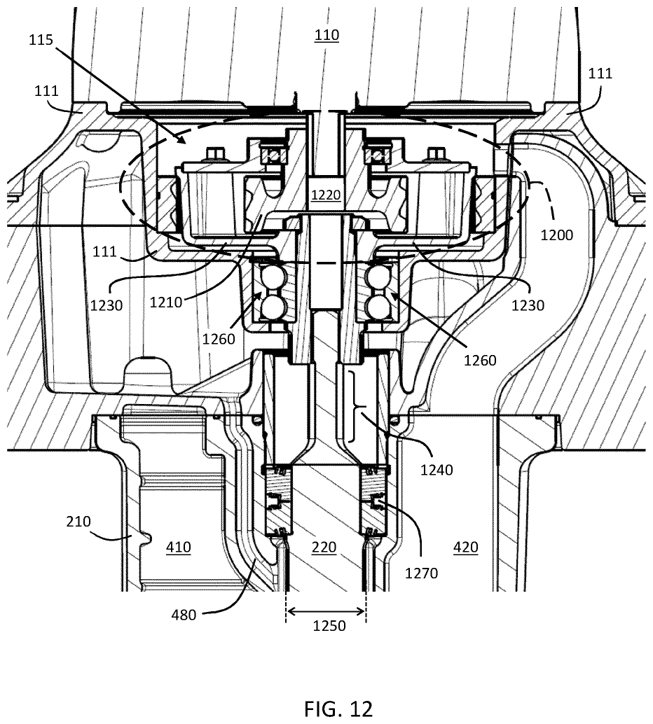

With reference to FIG. 4A, the oil channel 420 has an output aperture 426 arranged to eject the flow of oil 421 in connection to the motor interface 115, thereby lubricating one or more moving parts comprised in the motor interface, such as the planetary gear arrangement 1200 illustrated in detail in FIG. 12.

As mentioned above, the drive unit 100 preferably also comprises an oil return channel 480 extending from the motor interface 115 to a port 485 arranged facing the drive shaft 220. This return channel 480 is a preferred way to close the oil circuit loop in the drive unit 100. The lubricant in the loop starts the circuit at the moving parts in connection to the bevel gear arrangement where the bevel gear is used to pump the loop through the oil channel 420 up through the drive unit 100. The oil then exits the oil channel via the output aperture 426 where it is ejected onto the planetary gear arrangement, thus lubricating the planetary gear arrangement 1200. After the planetary gear the oil moves downwards (by gravitational pull) towards the oil return channel, which opens up in connection to the drive shaft 220. The oil therefore lubricates the drive shaft 220 before ending up back at the bevel gear arrangement. An oil reservoir may be formed in the drive unit body 210 in connection to the second bevel gear 242, and/or in connection to the planetary gear arrangement 1200.

According to an option, ribs, protruding buttons, or a chevron pattern is formed on an internal wall of the oil channel 420. These structures promote heat transfer from the lubricant to the surrounding seawater through the material in the drive unit body 210. Fins or ribs arranged extending in the direction of the oil flow 421 can also be used with advantage. Such fins or ribs do not hamper the flow as much as more random protrusions do. The drive unit body 210 is preferably at least partly formed in a Manganese bronze alloy or NiBrAl, which promotes heat transfer from the lubricant in the oil channel to the surrounding seawater.

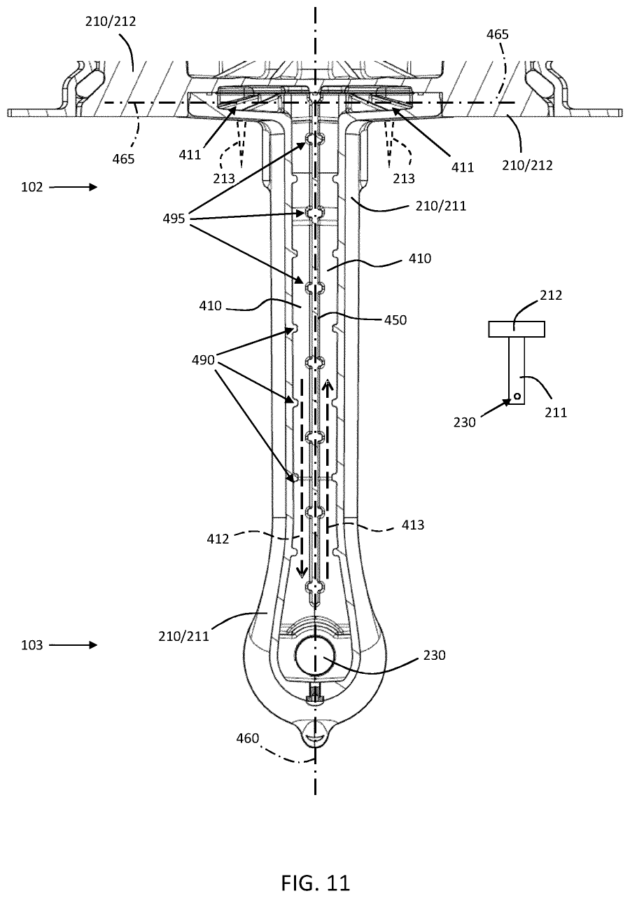

FIG. 11 illustrates some other interesting details of an example drive unit 100 which comprises a drive unit body 210 with a first part 211 and a second part 212, schematically illustrated in the insert in FIG. 11.

The first part 211 of the drive unit body 210 is arranged elongated along a center plane 460 of the drive unit and supports a propeller shaft 230 on a lower end 103. The center plane 460 is the vertical center plane discussed above, which extends in a longitudinal direction F, B of the marine vessel 101 in use.

The second part 212 of the drive unit body 210 is attached to the first part 211 at an upper end 102 of the first part 211 and arranged extending along a hull plane 465 perpendicular to the center plane 460 and extending in a lateral direction S, P of the marine vessel 101 in use.

The drive unit body 210 comprises the closed cooling compartment 410 arranged to be fluidly connected to a closed cooling circuit 150 configurable to cool the one or more electric components 110, 120, 130 of the electric propulsion system, as discussed above. However, in this example, the closed cooling compartment 410 has an extension 411 parallel to the hull plane 465 in the second part 212 which exceeds the extension parallel to the hull plane 465 in the first part 211. In other words, the closed cooling compartment extends laterally to follow the contour of the hull 140 at the interface between drive unit and vessel. This increases the contact surface between coolant and drive unit body material at the upper part of the drive unit. As illustrated in FIG. 11, the part of the closed cooling compartment which follows the contour of the hull has a flat and wide cylindrical shape which is fluidly connected to the cooling channels of vertical extension. The central axis of this cylinder cavity is essentially vertical with the plane surfaces of the cylinder extending in the horizontal plane. The lower flat surface of this cylindrical cavity illustrated in FIG. 11 essentially extends along the contour of the hull, and it is therefore possible for heat to pass from the coolant inside the cylindrical cavity through the drive unit body wall into the surrounding seawater. The increased cooling efficiency obtained in this manner in some cases enable the use of a closed cooling compartment, i.e., one without seawater entering into the system, which is an advantage.

It is noted in FIG. 11 that the second part 212 comprises walls that define the cavity. The inner walls of the second part 212 form the upper part of the closed cooling compartment. The coolant flow 412 extends from the laterally extending cavity 411 downwards into the closed cooling compartment 410 and then upwards again to enter the laterally extending cavity 411. The laterally extending cavity thus forms a type of buffer which holds an amount of coolant. It is an advantage that the volume of coolant is increased by the laterally extending cavity, i.e., the extension 411. The extension 411 is integrated into the connection between the drive unit and hull, and therefore does not add to the spatial footprint to the drive unit, which is an advantage.

A plurality of ribs 490 are optionally formed in the first part 211 of the drive unit body 210. These ribs protrude into the closed cooling compartment 410 as illustrated in FIG. 11. The ribs 490 are extending parallel to the center plane 460 and transversal to a coolant flow 412, 413 in the closed cooling compartment 410, thereby disturbing laminar flow of the coolant as it flows through the closed cooling compartment.

The example closed cooling compartment 410 illustrated in FIG. 11 is separated into two parts by an inner wall 450 aligned with the center plane 460. Ribs 495 are optionally arranged protruding out from the inner wall 450 and into the closed cooling compartment 410. The ribs 495 arranged protruding out from the inner wall 450 are preferably offset with respect to the ribs 490 protruding into the closed cooling compartment 410 from the outer wall of the drive unit body 210. Of course, protruding buttons or a chevron pattern can also be formed inside the closed cooling compartment 410 in order to disturb the coolant flow and thus increase the heat transfer between the coolant in the closed cooling compartment and the surrounding seawater. To further promote heat transfer between coolant and the surrounding seawater, external fins 213 can be configured to extend out from the second part 212 parallel to the center plane 460.

The drive unit body 210 is at least partly formed in a Manganese bronze alloy or Nibral, which are materials associated with good heat transfer characteristics. Also, the outer surface of the drive unit 100 is preferably left uncoated such that the material of the drive unit body 210 makes direct contact with the surrounding water. I.e., there is no paint or other form of protective coating applied to the outside or inside surface of the drive unit body 210. An aluminum drive unit body coated with paint of some form can of course also be contemplated, but this would negatively affect the heat transfer to the surrounding seawater

FIG. 12 illustrates some interesting details of an optional motor interface 115 which can be used to connect an electric machine to the drive unit. FIG. 12 shows a drive unit 100 with a drive shaft 220 that is arranged extending from the motor interface 115 through the drive unit body 210 to a bevel gear arrangement 240 arranged to rotatably connect the drive shaft 220 to the propeller shaft 230, as discussed above. In this example, a helical gears planetary gear arrangement 1200 is arranged in connection to the motor interface 115 to connect an electric machine 110 to the drive shaft 220. The helical gears provide an increased contact surface area between the gears, which reduces noise. The helical gears generate axial forces on the planetary wheels. Hence, axial needle bearings are preferably arranged to support the planetary wheels in their axial directions.

A central sun gear 1210 of the planetary gear arrangement 1200 may be directly connected to a motor axle 1220 of the electric machine 110, which allows the motor interface to be designed in a compact manner. By directly mounting the planetary gear onto the motor axle, a high strength torque transferring mechanism between electric machine and planetary gear is also achieved, which is an advantage. The drive unit 100 optionally also comprises a motor mount 111 arranged to support the electric machine 110. The motor mount 111 is integrally formed with a support for holding the planetary gear arrangement 1200, resulting in a high mechanical strength design. It is also an advantage that the different components can be integrally formed in one piece which can be molded or machined in a single production step.

The support for holding the planetary gear arrangement 1200 may also comprise an output aperture 426 of an oil channel 420 arranged to eject a flow of oil 421 onto the planetary gear arrangement 1200. In fact, the oil channel can also be integrally formed in the drive unit body 210, which is a cost effective means of manufacturing the drive unit.

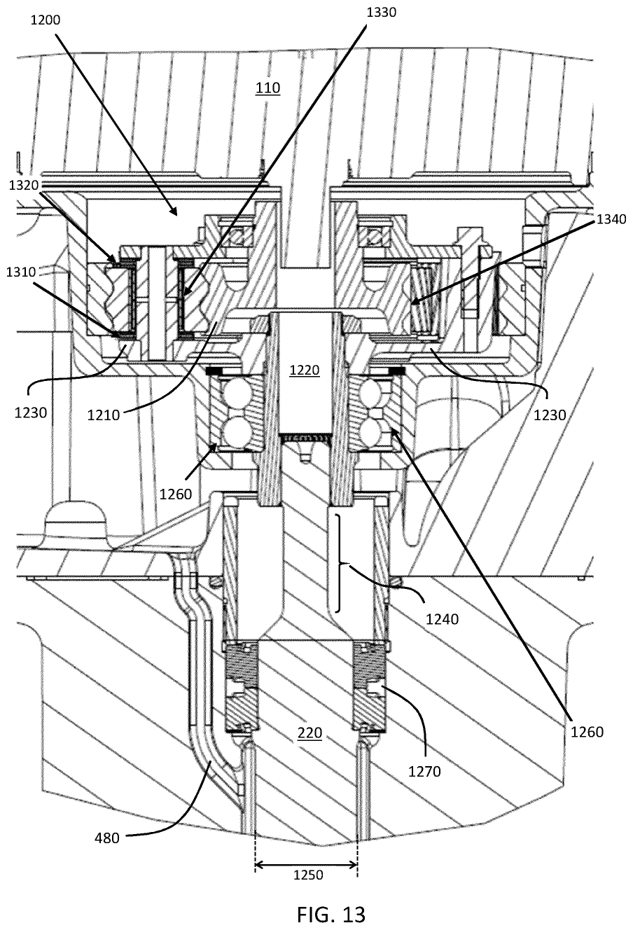

According to some aspects, the planetary gear arrangement 1200 comprises a planet gear carrier 1230 fixedly connected to the drive shaft 220. The planet gear carrier supports planet wheels in a known manner and reduces the speed of the motor axle 1220 to a lower speed on the drive shaft 220. As exemplified in FIG. 13, each planet wheel may be axially supported by upper and lower axial needle bearings 1310, 1320, and each planet wheel is also radially supported by a respective radial needle bearing 1330.

The drive shaft 220 may also comprise a portion of reduced diameter 1240 compared to a nominal diameter 1250 of the drive shaft 220. This portion of reduced diameter 1240 is a deformation zone which reduces noise in the transmission between electric machine and propeller shaft, which is an advantage. The portion of reduced diameter 1240 is also weaker than the rest of the drive shaft, which means that it will break before other components in the transmission, which is an advantage. The drive shaft 220 is rotatably supported by an upper bearing 1260 and by a lower bearing 1270 on either side of the drive shaft portion of reduced diameter 1240. The upper bearing 1260 is preferably an angular contact ball bearing with double rows.

The teeth 1340 on the central sun gear 1210 are not straight cut. This increases the contact area between the sun gear and the planetary gears, which results in reduced noise levels. The helical gears of the central sun gear results in axial forces on the planet wheels, which are absorbed by the axial needle bearings 1310, 1320.

1. A drive unit for a marine vessel, the drive unit comprising a drive unit body with a first part and a second part, where the first part of the drive unit body is arranged elongated along a center plane of the drive unit, where the first part of the drive unit body supports a propeller shaft on a lower end, where the center plane is vertical and extends in a longitudinal direction of the marine vessel in use,
where the second part of the drive unit body is attached to the first part at an upper end of the first part and arranged extending along a hull plane perpendicular to the center plane and extending in a lateral direction of the marine vessel in use, the drive unit body comprising a closed cooling compartment arranged to be a part of a closed cooling circuit configured to cool one or more electric components of the marine vessel,
where the closed cooling compartment has an extension parallel to the hull plane in the second part which exceeds the extension parallel to the hull plane in the first part where the closed cooling compartment extends to follow a contour of a hull of the vessel at an interface between the hull and the drive unit such as to increase a contact area of the closed cooling compartment against surrounding seawater,
wherein the closed cooling compartment is arranged to hold an oil-based coolant or a water-based coolant, where a coolant pump of the drive unit is connected to a forward end of the propeller shaft and arranged to pump coolant through the closed cooling compartment.

2. The drive unit according to claim 1, where a plurality of ribs is formed in the first part of the drive unit body arranged to protrude into the closed cooling compartment, the ribs extending parallel to the center plane and transversal to a coolant flow in the closed cooling compartment.

3. The drive unit according to claim 1, where the closed cooling compartment is separated into two parts by an inner wall aligned with the center plane, where ribs are arranged protruding out from the inner wall and into the closed cooling compartment.

4. The drive unit according to claim where the ribs arranged protruding out from the inner wall are offset with respect to ribs protruding into the closed cooling compartment from an outer wall of the drive unit body.

5. The drive unit according to claim 1, where protruding buttons or a chevron pattern is formed inside the closed cooling compartment.

6. The drive unit according to claim 1, where external fins are configured to extend out from the second part parallel to the center plane

7. The drive unit according to claim 1, where the drive unit body is at least partly formed in a Manganese bronze alloy or Nibral.

8. The drive unit according to claim 1, where the outer surface of the drive unit is uncoated such that the material of the drive unit body makes direct contact with the surrounding water.

9. The drive unit according to claim 1, where the closed cooling compartment is arranged in a forward part of the drive unit and facing in a travelling direction of the marine vessel in use.

10. A marine vessel comprising a drive unit according to claim 1.
